(19) United States
(12) Patent Application Publication
(10) Pub. No.: US 2010/0053212 A1
(43) Pub. Date: Mar. 4, 2010

(54) PORTABLE DEVICE HAVING IMAGE OVERLAY FUNCTION AND METHOD OF OVERLAYING IMAGE IN PORTABLE DEVICE

(76) Inventors: Mi-Sun Kang, Gyeonggi-do (KR); Jung-Bum Oh, Gyenggi-do (KR)

Correspondence Address: HARNESS, DICKEY & PIERCE, P.L.C., P.O. BOX 8910, RESTON, VA, 20195, US

(21) Appl. No.: 12/312,303

(22) PCT Filed: Sep. 10, 2007
(86) PCT No.: PCT/KR2007/004377

§ 371 Date: May 5, 2009

(30) Foreign Application Priority Data
Nov. 14, 2006 (KR) 10-2006-0112122

(51) Int. Cl. G09G 5/00; H04N 7/14

(52) U.S. Cl. 345/629; 348/14.01; 348/E07.078

(57) ABSTRACT

Disclosed are a portable device having an image overlay function and a method of overlaying images in the portable device, which can photograph a plurality of images within areas having no overlapping regions between the areas in real time, and can overlay the photographed images. A first camera unit photographs a first area, and a second camera unit photographs a second area which does not overlap with the first area. A first codec and a second codec encode a first area image and a second area image, respectively, which have been obtained by photographing the first area and the second area. An image processing unit overlays the encoded first area image and the encoded second area image. Therefore, it is possible to photograph a plurality of subjects existing in at least two areas having no overlapping regions between the two areas in real time, to overlay the photographed images, and to transmit the overlaid image to a portable device of a counterpart for video telephone communication.

### TECHNICAL FIELD

Example embodiments of the present invention relates to portable devices, and more particularly relates to portable devices having an image overlay function, which can be employed by the portable devices having an image photographing function, and methods of overlaying images in the portable devices.

### BACKGROUND ART

As mobile communication technology has been evolved to the 3.5 generation mobile communication technology, high-speed downlink packet access (HSDPA) services have begun to be provided, so that video telephones are in common use, thereby making it possible for a user to communicate with a counterpart while viewing the counterpart by means of the portable device of the user, beyond the conventional communication aiming at voice communication and short message transmission.

According to video telephone communication, a portable device of a caller (or originator, sender) photographs the appearance of the caller by means of a camera installed therein, processes the photographed image according to a transmission standard protocol for video telephone communication, and transmits the processed image to a recipient (or receiver) of the video telephone communication. In addition, the portable device of the caller converts an image signal, which has been received from the recipient of the video telephone communication, so as to be displayed on a display unit of the portable device, and displays an image corresponding to the received image signal on the portable device of the caller, thereby making it possible that the caller and recipient can communicate with each other while viewing the counterpart.

The conventional portable device having an image communication function includes one camera, photographs only the caller and his/her background through the camera, and transmits only the caller image and his/her background image to a portable device of a counterpart for the image communication, so that the conventional portable device cannot satisfy various demands of users.

For example, when a person managing a field of construction work uses the conventional video telephone in order to report a field situation to the head office, it is impossible to photograph and transmit the appearance of the caller because a camera installed in the portable device must face the field of construction work in order to photograph the field of construction work, and it is difficult to perform voice communication because a microphone installed in the portable device faces away from the caller during the photographing of the field of construction work.

Korean Patent Application Publication No. 2003-8728 (entitled “Mobile communication terminal having the function of video Communication”) discloses a mobile communication terminal which includes a plurality of image-pickup modules to photograph subjects, to separate subjects from images photographed by the cameras, to overlay the separated subjects, to combine the overlaid subjects with a background image, and to transmit the subjects combined with the background image.

However, the mobile communication terminal disclosed in Korean Patent Application Publication No. 2003-8728 includes the plurality of image-pickup modules arranged so as to photograph areas having an overlapping region, to photograph the same subject, to separate the same subjects from photographed images, to overlay the separated subjects, to combine the overlaid subjects with a background image, and to transmit the overlaid subjects together with the background image. Thus, the mobile communication terminal disclosed in Korean Patent Application Publication No. 2003-8728 does not make a large difference in photographed contents as compared with the conventional portable device which transmits an image photographed by one camera therein.

Therefore, the mobile terminal disclosed in Korean Patent Application Publication No. 2003-8728 does not overcome the defect of the conventional portable device, which simply photographs only one subject to transmit only one subject.

### DISCLOSURE OF INVENTION

### Technical Problem

Accordingly, the present invention is provided to substantially obviate one or more problems due to limitations and disadvantages of the related art.

It is a feature of the present invention to provide portable devices having an image overlay function, which can photograph, in real time, a plurality of subjects existing in at least two areas that have no overlapping regions between the subjects, and can overlay the photographed subjects.

It is another feature of the present invention to provide methods of overlaying images in portable devices, which can photograph, in real time, a plurality of subjects existing in at least two areas that have no overlapping regions between the subjects, and can overlay the photographed subjects.

### Technical Solution

In one example embodiment, a portable device having an image overlay function includes: a first camera unit configured to photograph a first area; a second camera unit configured to photograph a second area which does not overlap with the first area; a first codec configured to encode an image of the photographed first area; a second codec configured to encode an image of the photographed second area; and an image processing unit configured to overlay the encoded first area image and the encoded second area image. The image processing unit may receive the encoded first area image, extract a predetermined-area image from the encoded first area image, and overlay the extracted predetermined-area image and the encoded second area image. The photographed first area may include a user image containing an appearance of the user, and the photographed second area may include a foreground image containing a foreground viewed by the user. The image processing unit may apply a transparency effect with respect to at least one image of the extracted predetermined-area image and the encoded foreground image, and overlay the extracted predetermined-area image and the encoded foreground image. The image processing unit may include: a first filter configured to perform a sharpening operation with respect to the extracted predetermined-area image; and a second filter configured to process the encoded user foreground image to be smooth, and configured to remove a noise from the encoded foreground image. The first filter may include a sharpening filter, and the second filter may include a low pass filter which has at least one of a mean filter, a median filter, and a Gaussian filter. The first codec may encode the photographed user image at a first frame rate, and the second codec may encode the photographed user foreground image at a second frame rate which is lower than the first frame rate. The image processing unit may overlay the foreground image and the extracted predetermined-area image at every predetermined update cycle. The first codec and the second codec may convert a color format of the user image and a color format of the foreground image, respectively, which are provided from the first camera unit and the second camera unit, respectively. The portable device may further include: a moving-image codec configured to encode the overlaid image provided from the image processing unit so as to conform to a format for video telephone communication a controller configured to provide a user interface for setting an environment for the image overlay, and configured to provide information on the set environment to the image processing unit; a radio transceiver configured to convert a first baseband signal provided from the controller into a radio frequency signal to output the radio frequency signal through an antenna, and configured to convert a signal received through the antenna into a second baseband signal to provide the converted second baseband signal to the controller; and a display unit configured to display the overlaid image.

In another example embodiment, a method of overlaying images in a portable device includes: encoding a first area image and a second area image that do not overlap with each other; and overlaying the encoded first area image and the encoded second area image. The overlaying the encoded first area image and the encoded second area image may include: extracting a predetermined-area image from the encoded first area image; and overlaying the extracted predetermined-area image and the encoded second area image. The first area image may include a user image containing an appearance of the user, and the second area image may include a foreground image containing a foreground viewed by the user. The encoding a first area image and a second area image that do not overlap with each other includes converting color formats of the user image and the foreground image. The extracting the predetermined-area image may include: extracting the predetermined-area image from the encoded user image to perform a sharpening operation with respect to the extracted predetermined-area image and processing the foreground image to be smooth to remove a noise from the foreground image. The overlaying the extracted predetermined-area image and the encoded second area image may include applying a transparency effect to at least one of the extracted predetermined-area image and the foreground image to overlay the extracted predetermined-area image and the user foreground image. The overlaying the extracted predetermined-area image and the encoded second area image may include overlaying the extracted predetermined-area image and the user foreground image at every predetermined update cycle. The overlaying the extracted predetermined-area image and the encoded second area image may include adjusting a size of the extracted predetermined-area image to overlay the size-adjusted predetermined-area image and the encoded second area image such that the size-adjusted predetermined-area image is disposed at a predetermined position within the encoded second area image. The overlaying the extracted predetermined-area image and the encoded second area image may include adjusting a position of the predetermined-area image in the encoded second area image to overlay the predetermined-area image and the encoded second area image so that the extracted predetermined-area image is disposed at a predetermined position within the encoded second area image.

### BRIEF DESCRIPTION OF THE DRAWINGS

Example embodiments of the present invention will become more apparent by describing in detail example embodiments of the present invention with reference to the accompanying drawings, in which:

FIG. 1 is a block diagram illustrating the configuration of a portable device having an image processing apparatus according to an example embodiment of the present invention;

FIG. 2 is a flowchart illustrating an image overlaying procedure by the portable device according to an example embodiment of the present invention;

FIG. 3 is a flowchart illustrating an image overlaying procedure by the portable device according to another example embodiment of the present invention;

FIGS. 4 through 6 are views illustrating screens for explaining the image overlaying procedure according to an example embodiment of the present invention; and

FIGS. 7 through 10 are views illustrating overlaid images according to other example embodiments of the present invention.

### MODE FOR THE INVENTION

While the invention is susceptible to various modifications and alternative forms, specific embodiments thereof are shown by way of example in the drawings and will herein be described in detail.

However, it should be understood that there is no intent to limit the invention to the particular forms disclosed, but on the contrary, the invention is to cover all modifications, equivalents, and alternatives falling within the spirit and scope of the invention.

Hereinafter, one example embodiment of the present invention will be described in more detail with reference to the accompanying drawings. In the following description, elements having the same functions as those of the elements which have been previously described will be indicated with the same reference numerals, and a detailed description thereof will be omitted.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

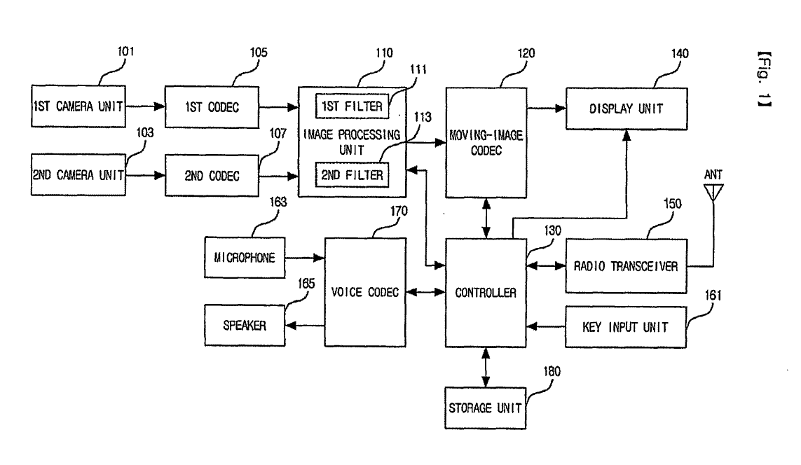

FIG. 1 is a block diagram illustrating the configuration of a portable device having an image processing apparatus according to an example embodiment of the present invention.

Referring to FIG. 1, the portable device having the image processing apparatus according to an example embodiment of the present invention includes a first camera unit 101, a second camera unit 103, a first codec 105, a second codec 107, an image processing unit 110, a moving-image codec 120, a controller 130, a display unit 140, a radio transceiver 150, a key input unit 161, a microphone 163, a speaker 165, a voice codec 170, and a storage unit 180. The image processing unit 110 includes a first filter 111 and a second filter 113 therein.

The first camera unit 101 and second camera unit 103 convert optical signals of subjects, which have been incident through the respective optical devices (not shown), into electrical signals by means of the respective image sensors (not shown),convert the electrical signals into digital image signals by means of the respective analogy-to-digital (A/D) converters included therein, and output the digital image signals.

When the first camera unit 101 photographs a subject within a first area, and the second camera unit 103 photographs a subject within a second area, it is preferred that there are no overlapping regions between the first and second areas. However, the first and second areas may partially overlap each other, or may entirely overlap each other.

According to an example embodiment of the present invention, when the portable device is a slide-type portable device including a slide section and a body section, the first camera unit 101 may be installed on the slide section of the portable device in such a manner as to face the user so as to photograph the user within the first area, while the second camera unit 103 may be installed on the body section of the portable device in such a manner as to face the opposite direction of the first camera unit 101 so as to photograph a foreground within the second area. The term “foreground” represents an area which lies in front of the user of the portable device in the user s viewing direction.

For example, the foreground may include a landscape viewed by the user, a field of construction work, and a subject desired to be shown to a counterpart for video telephone communication.

Also, according to another example embodiment of the present invention, the first camera unit 101 and the second camera unit 103 may be implemented in such a manner as to be rotatably installed so that the first camera unit 101 and the second camera unit 103 can photograph subjects which exist in first area and second area having no overlapping regions between the first and second areas. For example, the first camera unit 101 may photograph a subject of a first area which exists at a position rotated by a predetermined angle from the front face of the user, instead of the front face of the user, and the second camera unit 103 may photograph a subject of a second area which exists at a position rotated by a predetermined angle from the foreground.

Also, according to another example embodiment of the present invention, the first camera unit 101 and the second camera unit 103 may be implemented in such a manner as to be rotatably installed so that the first camera unit 101 and the second camera unit 103 may photograph subjects which exist in first area and second area, e.g., a side area of the user, partially or entirely overlapping each other.

Hereinafter, the following descriptions will be given about a case where the appearance of the user exists in a first area, and a foreground exists in a second area.

The first codec 105 is connected to the first camera unit 101, receives a digital image signal obtained through the photographing of the first camera unit 101, and converts the color format of the digital image signal, thereby reducing the size of image data. For example, the first codec 105 may receive raw image data of an RGB (Red, Green and Blue) format from the first camera unit 101, and convert the raw image data of the RGB format into image data of an YCbCr 420 format through encoding.

The second codec 107 is connected to the second camera unit 103, receives a digital image signal obtained through the photographing of the second camera unit 103, and converts the color format of the digital image signal, thereby reducing the size of image data. For example, the second codec 107 may receive raw image data of the RGB format from the first camera unit 101, and convert the raw image data of the RGB format into image data of the YCbCr 420 format through encoding.

The image processing unit 110 is connected to both the first codec 105 and the second codec 107, receives first image data obtained by photographing the appearance of the user within the first area from the first codec 105, and receives second image data obtained by photographing a foreground, i.e., a subject viewed by the user, within the second area from the second codec 107. Then, the image processing unit 110 performs a predetermined image processing operation with respect to the first and second image data, and outputs an overlaid image of the first and second image data. The overlaid image output from the image processing unit 110 corresponds to an image in which the appearance of the user is overlaid on the foreground viewed by the user.

To this end, the image processing unit 110 receives the first image data, which has been obtained by photographing the user s appearance and the user s background, and extracts image data of a predetermined area from the first image data according to image overlay environment information set by the user.

That is, the image processing unit 110 extracts image data of a predetermined area corresponding to the image overlay environment information—for example the position, the size and the shape of an object to be extracted by the user—set by the user, from the first image data.

For example, when the user sets extraction information as an ellipse, which has a predetermined size and position corresponding to the user s face, in order to extract only the user s face from an image obtained by photographing the appearance of the user, the image processing unit 110 extracts only a face portion corresponding to the set ellipse from the first image data provided by the first codec 105.

Then, the image processing unit 110 performs a sharpening operation with respect to the extracted object by means of the first filter 111. The first filter 111 may include a sharpening filter.

In addition, the image processing unit 110 receives the second image data, which has been obtained by photographing a foreground viewed by the user, from the second codec 107, and processes the second image data according to preset image overlay environment information. That is, the image processing unit 110 removes noise existing in the second image data by means of the second filter 113, thereby converting the second image data into smooth image data.

The second filter 113 may be a low pass filter, such as a mean filter, a median filter, and a Gaussian filter.

After having finishing the processing with respect to the second image data and the predetermined-area image data extracted from the first image data, the image processing unit 110 may perform a transparency processing on the second image data and/or the predetermined-area image extracted from the first image according to transparency effect information established by the user, and overlay the predetermined-area image and the second image data to which the transparency effect has been applied, thereby outputting an overlaid image.

For example, the image processing unit 110 may perform a semi-transparency processing on the predetermined-area image data extracted from the first image data and/or the second image data by assigning an alpha value to each of the predetermined-area image data and the second image data, and then overlay the extracted predetermined-area image data and the second image data.

Also, after an overlaid image has been displayed on the display unit 140, the user may set a semi-transparency effect while viewing the overlaid image, and the image processing unit 110 may change the semi-transparency effect applied to the extracted determined area and the second image data in real time depending on the semi-transparency effect set by the user.

In the portable device according to an example embodiment of the present invention, overlaid images can be processed and outputted at a rate of 15 frames per second. Also, when the user sets a predetermined update cycle for the second image data which corresponds to a photographed foreground image, the image processing unit 110 may update the second image data according to the set update cycle (e.g. 5 seconds or 75 frames), and overlay the updated second image data and the extracted predetermined-area image data.

For example, when video telephone communication is performed by the portable device, the first image data obtained by photographing the appearance of the user may be encoded at a rate of 15 frames by the first codec 105, and may be subjected to a predetermined-area extracting process and a sharpening process by the image processing unit 110, the second image data obtained by photographing a foreground may be encoded at a rate of 75 frames by the second codec 107 because the second image data have a low variation, and may be subjected to an image processing, such as a noise removing process, a low pass filtering process, etc., by the image processing unit 110, and then the first image data and the extracted predetermined-area image data are overlaid.

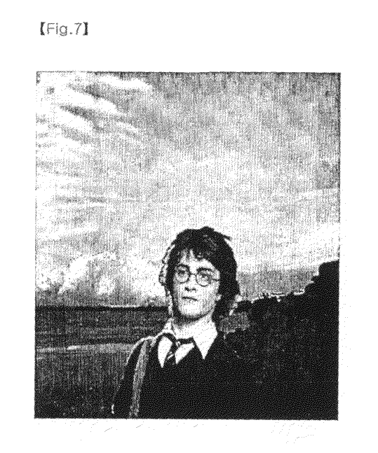

When the appearance of the user and the foreground image are overlaid, it is possible to adjust the size of an image expressing the appearance of the user, and it is possible to adjust the position, which is disposed within the foreground image,of the image expressing the appearance of the user. In addition, the size and the position of the appearance of the user may be adjusted at the same time. Detailed descriptions regarding the size and the position of the appearance of the user will be given later with reference to FIGS. 7 through 10.

An overlaid image provided from the image processing unit 110 may be generated as a still image, or alternatively may be generated as a moving image (or a moving picture) through the moving-image codec 120.

In an video telephone mode, the moving-image codec 120 may receive an overlaid image of a caller (or originator, sender) from the image processing unit 110, encode the overlaid image into a predetermined video telephone communication format, and then provide the encoded overlaid image of the predetermined image communication format to the controller 130. Also, the moving-image codec 120 may receive an image of a counterpart for video telephone communication from the controller 130, decode the received image, and then provide the decoded image to the display unit 140.

The moving-image codec 120 may include, for example, H.261, H.263, H.264, and MPEG-4 codecs, and may include an H.263 codec and a codec satisfying MPEG-4 Simple Profile Level 0 for the sake of video telephone communication.

The controller 130 controls the overall function of the portable device. The controller 130 transmits an overlaid image provided by the moving-image codec 120 to a portable device of a counterpart for the image communication through the radio transceiver 150, and stores the overlaid image in the storage unit 180 when a key event signal requesting for a store operation is generated. Also, the controller 130 receives an image of a counterpart for video telephone communication through the radio transceiver 150, and provides the image of the counterpart to the moving-image codec 120.

In addition, the controller 130 displays a user interface screen for setting of an image overlay environment on the display unit 140, stores image overlay environment information set through the key input unit by the user in the storage unit 180, and provides the set image overlay environment information to the image processing unit 110.

The image overlay environment information may include, for example, a camera selection, a foreground update cycle, a position of an object to be extracted, a size of the object, a shape of the object, a value set for the semi-transparency effect, a location where the object is to be disposed within the foreground, etc.

The display unit 140 may include, for example, a liquid crystal display (LCD), displays the functions of the portable device and the user interface for selecting the functions, and displays execution screens for various application programs installed in the portable device.

Especially, when video telephone communication is performed, the display unit 140 displays an overlaid image of the user (i.e., the caller) and an image of a counterpart for the video telephone communication.

The radio transceiver 150 converts a radio frequency (RF) signal received through an antenna (ANT) into a baseband signal, and provides the baseband signal to the controller 130. Also, the radio transceiver 150 converts a baseband signal provided from the controller 130 into a radio frequency signal, and outputs the radio frequency signal through the antenna. When video telephone communication is performed, the baseband signal provided to the controller 130 may include an image signal and voice signal of a counterpart for video telephone communication, and the baseband signal provided from the controller 130 may include an image signal and voice signal of the caller, i.e., the user of the portable device.

The key input unit 161 may include a plurality of letter and numeral input keys, and function keys for executing special functions, and provides the controller 130 with a key event signal corresponding to a key operation by the user. Especially, the key input unit 161 provides the controller 130 with a key event signal corresponding to a key operation for setting an image overlay environment. Although FIG. 1 shows the key input unit 161 as an example of an input means for receiving an input from the user, input apparatuses, such as a touch screen, a touch keypad, etc., other than the key input unit 161, may be used as the input means.

The microphone 163 receives the voice of the caller while video telephone communication is being performed, converts the voice into an electrical signal, and provides the electrical signal to the voice codec 170. The speaker 165 receives a voice signal of a counterpart for video telephone communication from the voice codec 170, and outputs the voice signal as a voice signal of an audio-frequency band.

The voice codec 170 encodes the voice signal of the caller provided from the microphone 163 into a predetermined format, and then provides the controller 130 with the voice signal of the predetermined format. In addition, the voice codec 170 receives the voice signal of the counterpart for video telephone communication from the controller 130, decodes the voice signal of the counterpart, and provides the decoded voice signal to the speaker 165.

The voice codec 170 may use a codec standard, such as G.711, G.723, G.723.1, G.728, etc., in order to encode and decode voice.

The storage unit 180 stores a system program, such as an operating system for the basic operation of the portable device, various application programs, and temporarily stores data generated while the portable device executes the application programs. Especially, the storage unit 180 may store an overlaid image and/or image overlay environment information, as selected by the user.

Although FIG. 1 shows the moving-image codec 120, the image processing unit 110, the first codec 105, and the second codec 107 as separate blocks, the moving-image codec 120, the image processing unit 110, the first codec 105, and the second codec 107 may be integrated into one chip according to another example embodiment of the present invention. Also, the controller 130 and/or the radio transceiver 150, in addition to the moving-image codec 120, the image processing unit 110, the first codec 105, and the second codec 107, may be integrated into one chip.

Although FIG. 1 shows an example in which two cameras are used to photograph subjects within the first and second areas having no overlapping regions each other, three cameras may be used to photograph subjects within first, second and third areas having no overlapping regions one another according to another example embodiment of the present invention. Also, according to still another example embodiment of the present invention, three cameras may be used in such a manner that two cameras photograph first and second areas partially or entirely overlapping each other, and the other camera photographs a third area not overlapping with the first and second areas photographed by the two cameras.

As described with reference to FIG. 1, the portable device having an image overlay function according to an example embodiment of the present invention includes two camera units for photographing different subjects, such as the appearance of the user and a foreground, located at first and second areas having no overlapping regions between the first and second area, encodes two images photographed by the respective cameras, overlays the two images by extracting a predetermined-area image and by performing an image processing procedure, and transmits a resultant overlaid image to a counterpart for video telephone communication, or stores the resultant overlaid image in the storage unit of the portable device.

Therefore, in an environment such as a sightseeing resort or a field of construction work, an caller of video telephone communication can simultaneously transmit his/her own appearance and a foreground viewed by him/her to a counterpart of the video telephone communication through video telephone communication, and also can store the photographed image in the storage unit before transmitting the photographed image to the counterpart through multimedia messaging service (MMS).

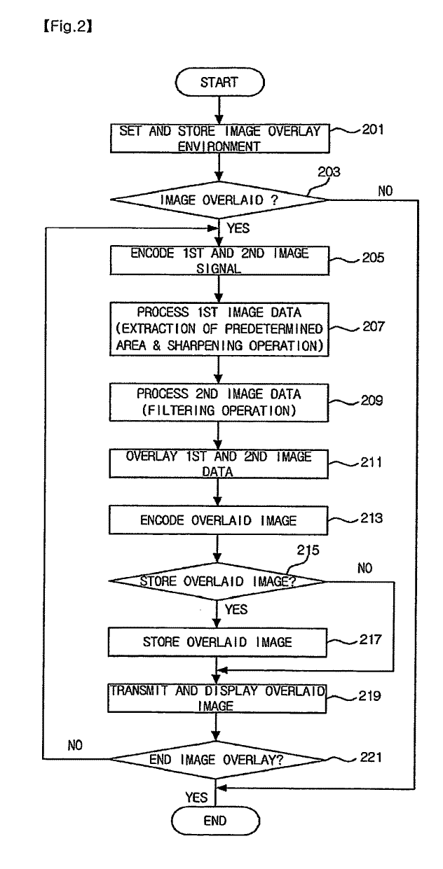

FIG. 2 is a flowchart illustrating an image overlaying procedure by the portable device according to an example embodiment of the present invention. In FIG. 2, first image data and second image data are image-processed at the same frame rate and are overlaid.

Referring to FIG. 2, first, the controller 130 receives information on image overlay environment set through the key input unit 161 by the user, and stores information on the set image overlay environment in the storage unit 180 (step 201).

Thereafter, when a key event signal requesting image overlay is generated (step 203), the first codec 105 and second codec 107 encode first and second image signals provided from the first camera unit 101 and second camera unit 103, respectively (step 205).

Then, the image processing unit 110 extracts predetermined-area image data from the first image data provided from the first codec 105 according to the control of the controller 130, and performs an image sharpening process with respect to the extracted area by means of the first filter 111 (step 207). In this case, the first image data may correspond to, for example, the appearance of the user, and a user s background image photographed together with the appearance of the user. The predetermined-area image data may include area image data corresponding to the face of the user. The image processing unit 110 performs the extracting and image-sharpening processes as described above based on the set environment information provided from the controller 130.

The image processing unit 110 performs an image processing operation with respect to the second image data provided from the second codec 107 (step 209). That is, the image processing unit 110 removes noise included in the second image data by means of the second filter 113, and performs a processing for making the image smooth so that an overlaid image can be shown naturally. The second image data may correspond to an image obtained by photographing a foreground viewed by the user, i.e., the area in front of the user.

Next, the image processing unit 110 performs a semi-transparency process with respect to the second image data and/or a predetermined image extracted from the first image data, based on a setting value for the semi-transparency effect provided from the controller 130, and overlays the semi-transparency processed images so as to produce an overlaid image (step 211). In this case, the image processing unit 110 may adjust the size of the predetermined image extracted from the first image data, and a location of the predetermined image where the predetermined image is to be disposed.

Thereafter, the moving-image codec 120 encodes the overlaid image provided from the image processing unit 110 into a predetermined format, and provides the encoded overlaid image to the controller 130 (step 213).

The controller 130 receives the encoded overlaid image from the moving-image codec 120, and determines if an event signal requesting for storing the overlaid image has been activated (step 215). When it is determined that the event signal requesting for storing the overlaid image has been activated, the controller 130 stores the overlaid image in the storage unit 180 (step 217). In contrast, when it is determined that the event signal requesting for storing the overlaid image has not been activated, the controller 130 transmits the overlaid image through the radio transceiver 150 to a counterpart for video telephone communication, and simultaneously displays the overlaid image on the display unit 140 (step 219). The operations of storing, transmitting, and displaying the overlaid image may be performed at the same time.

Thereafter, the controller 130 determines if a key event signal requesting for an end of image overlay has been activated (step 221), and ends the image overlaying procedure according to an example embodiment of the present invention when it is determined that the key event signal requesting for the end of image overlay has been activated.

In contrast, when it is determined in step 221 that the key event signal requesting for the end of image overlay has not been activated, the controller 130 returns to step 205, so as to sequentially repeat step 205 and the following steps.

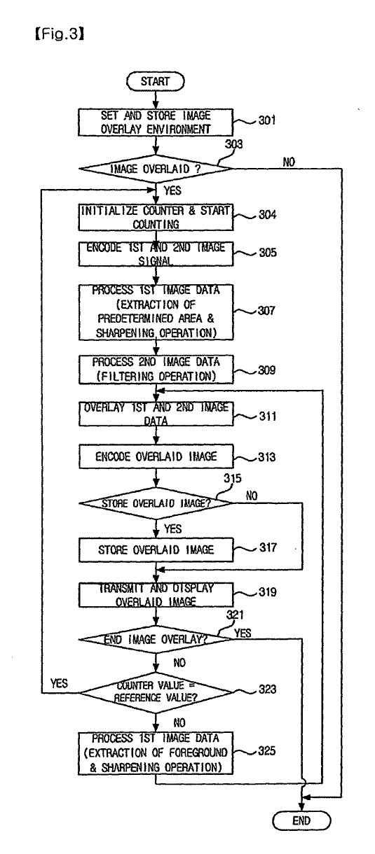

FIG. 3 is a flowchart illustrating an image overlaying procedure by the portable device according to another example embodiment of the present invention. In FIG. 3, the second image data are image-processed at a predetermined update cycle and then are overlaid with the first image data.

Steps 301 through 303 in FIG. 3 are the same as steps 201 through 203 in FIG. 2, and thus detailed descriptions thereof will be omitted.

When it is determined in step 303 of FIG. 3 that image overlays tarts, the controller 130 initializes a counter value, and starts counting (step 304). The controller 130 performs the counting in order to encode the second image data and to perform an image processing operation according to an update cycle for the second image data.

Steps 305 through 321 in FIG. 3 are the same as steps 205 through 221 in FIG. 2, respectively, and thus detailed descriptions thereof will be omitted to avoid duplication.

When it is determined that the image overlay does not end, as a result of step 321 of determining if the image overlay ends, the controller 130 determines if the counter value is the same as a preset reference value (step 323). When it is determined that the counter value is the same as the preset reference value, the controller 130 returns to step 304, so as to sequentially repeat step 304 and the following steps. Here, when the counter value is the same as the preset reference value, it means that it is time to update the second image data based on the update cycle.

In contrast, when it is determined in step 323 that the counter value is different from the preset reference value, it means that it is not time to update the second image data based on the update cycle. Therefore, in this case, the controller 130 proceeds to the next step, in which the controller 130 extracts predetermined-area image data from the first image data and performs an image sharpening process (step 325), and returns to step 311, so as to sequentially repeat step 311 and the following steps, thereby overlaying predetermined-area image data extracted from the current first image data on the second image data image-processed in the previous update cycle.

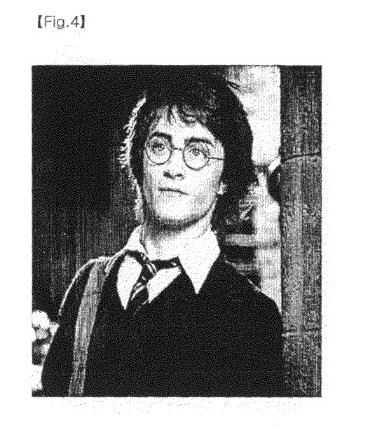

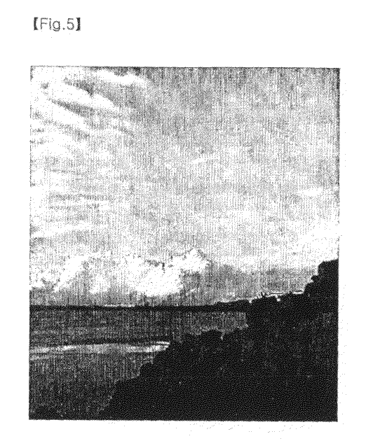

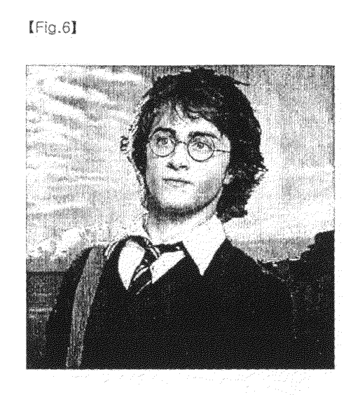

FIGS. 4 through 6 are views illustrating screens for explaining the image overlaying procedure according to an example embodiment of the present invention, in which FIG. 4 shows an example of a user s image photographed by the first camera unit, and FIG. 5 shows an example of a foreground image photographed by the second camera unit. FIG. 6 shows an overlaid image obtained by overlaying the user s image and the foreground image, shown in FIGS. 4 and 5.

Referring to FIGS. 4 through 6, in the portable device according to an example embodiment of the present invention, the first camera unit photographs the user s image shown in FIG. 4, and the second camera unit photographs the foreground image viewed by the user, as shown in FIG. 5. Then, the image processing unit extracts predetermined-area image data from the first image data obtained through photographing by the first camera unit, and overlays the extracted predetermined-area image data and the second image data obtained through photographing by the second camera unit.

FIG. 6 shows an example in which the image processing unit extracts only the appearance of the user, except for the user s background image, from the user s image shown in FIG. 4, and overlays the appearance of the user and the foreground image shown in FIG. 5.

FIGS. 7 through 10 show images overlaid according to other example embodiments of the present invention.

FIG. 7 shows an overlaid image obtained by reducing the size of the extracted user s image of FIG. 4 by about one fourth, by moving the position of the extracted user s image to a lower portion of the foreground image of FIG. 5, and by overlaying the moved extracted user s image on the foreground image.

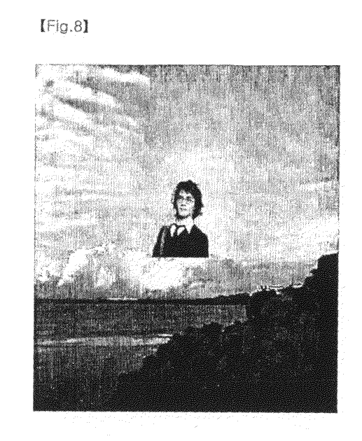

FIG. 8 shows an overlaid image obtained by reducing the size of the extracted user s image of FIG. 4 to a smaller size, by moving the position of the extracted user s image to the center portion of the foreground image of FIG. 5, and by overlaying the moved extracted user s image on the foreground image.

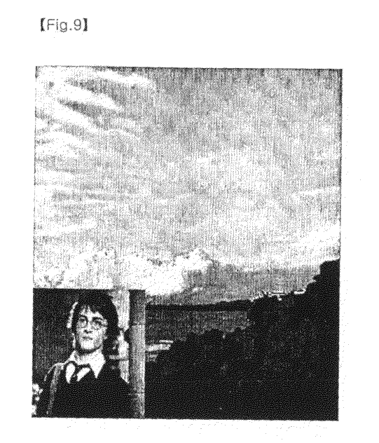

FIG. 9 shows an overlaid image obtained by reducing an entire image including the user s image and user s background image shown in FIG. 4, by about one ninth, by moving the position of the entire image to a lower left portion of the foreground image of FIG. 5, and by overlaying the entire image on the foreground image.

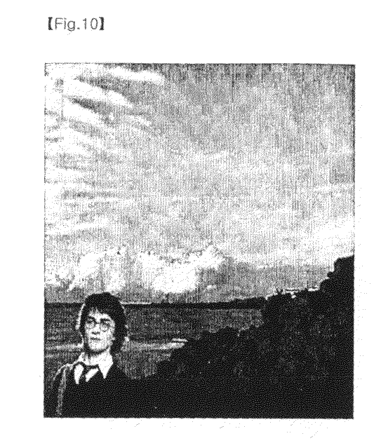

FIG. 10 shows an overlaid image obtained by reducing the size of the extracted user s image of FIG. 4 by about one ninth, by moving the position of the extracted user s image to the lower left portion of the foreground image of FIG. 5, and by overlaying the moved extracted user s image on the foreground image.

As shown in FIGS. 7 through 10, the size of the user s image can be adjusted to fit the preference of the user.

Also, as shown in FIGS. 7 through 10, the location of the user s image can be adjusted to any desired position, such as the center portion, the lower left portion, the lower right portion, the upper left portion, the upper right portion, etc., within the foreground image.

Although FIGS. 7 through 10 show examples in which the size of the user s image, among the user s image and foreground image having no overlapping regions each other, is adjusted, and the location of the user s image is adjusted within the foreground image, the present invention may be applied to the case where the size of a first image of first and second images having no overlapping regions each other, is adjusted, and the location of the first image is adjusted within the second image.

### INDUSTRIAL APPLICABILITY

The portable device having an image overlay function and the image overlaying method of the portable device according to example embodiments of the present invention, two cameras photograph a plurality of subjects, which exist in at least two area having no overlapping regions between the two area, the two photographed images are overlaid to produce an overlaid image, and the overlaid image are transmitted to a portable device of a counterpart for video telephone communication or the overlaid image are stored in the storage unit of the portable device. For example, the portable device can simultaneously photograph the appearance of the user and the foreground viewed by the user by means of two camera units, extract a predetermined-area image, such as the face of the user, from an image obtained by photographing the appearance of the user, overlay the extracted area and the image obtained by photographing the foreground so as to produce an overlaid image, and transmit the overlaid image to a portable device of a counterpart for video telephone communication or store the overlaid image in the storage unit of the portable device.

Therefore, by photographing and by overlaying a plurality of images having no overlapping regions each other in real time, an caller for video telephone communication can simultaneously transmit his/her own appearance and the foreground viewed by him/her to a counterpart for the video telephone communication through video telephone communication in an environment such as a sightseeing resort or a field of construction work, and can either store the photographed image in the storage unit of the portable device or transmit the photographed image to the portable terminal of the counterpart through multimedia messaging service (MMS), so that it is possible to utilize the video telephone function in various environments.

While the present invention has been shown and described with reference to certain example embodiments thereof, it will be understood by those skilled in the art that various changes in form and details may be made therein without departing from the spirit and scope of the invention as defined by the appended claims.

1. A portable device having an image overlay function, comprising:
a first camera unit configured to photograph a first area;
a second camera unit configured to photograph a second area which does not overlap with the first area;
a first codec configured to encode an image of the photographed first area;
a second codec configured to encode an image of the photographed second area; and
an image processing unit configured to overlay the encoded first area image and the encoded second area image.

2. The portable device of claim 1, wherein the image processing unit receives the encoded first area image, extracts a predetermined-area image from the encoded first area image, and overlays the extracted predetermined-area image and the encoded second area image.

3. The portable device of claim 2, wherein the photographed first area includes a user image containing an appearance of the user, and the photographed second area includes a foreground image containing a foreground viewed by the user.

4. The portable device of claim 3, wherein the image processing unit applies a transparency effect with respect to at least one image of the extracted predetermined-area image and the encoded foreground image, and overlays the extracted predetermined-area image and the encoded foreground image.

5. The portable device of claim 3, wherein the image processing unit comprises:
a first filter configured to perform a sharpening operation with respect to the extracted predetermined-area image and
a second filter configured to process the encoded foreground image to be smooth, and configured to remove noise from the encoded foreground image.

6. The portable device of claim 5, wherein the first filter includes a sharpening filter, and the second filter includes a low pass filter which has at least one of a mean filter, a median filter, and a Gaussian filter.

7. The portable device of claim 3, wherein the first codec encodes the photographed user image at a first frame rate, and the second codec encodes the photographed user foreground image at a second frame rate which is lower than the first frame rate.

8. The portable device of claim 3, wherein the image processing unit overlays the foreground image and the extracted predetermined-area image at every predetermined update cycle.

9. The portable device of claim 3, wherein the first codec and the second codec convert a color format of the user image and a color format of the foreground image, respectively, which are provided from the first camera unit and the second camera unit, respectively.

10. The portable device of claim 1, further comprising:
a moving-image codec configured to encode the overlaid image provided from the image processing unit so as to conform to a format for video telephone communication
a controller configured to provide a user interface for setting an environment for the image overlay, and configured to provide information on the set environment to the image processing unit;
a radio transceiver configured to convert a first baseband signal provided from the controller into a radio frequency signal to output the radio frequency signal through an antenna, and configured to convert a signal received through the antenna into a second baseband signal to provide the converted second baseband signal to the controller; and
a display unit configured to display the overlaid image.

11. A method of overlaying images in a portable device, comprising:
encoding a first area image and a second area image that do not overlap with each other and
overlaying the encoded first area image and the encoded second area image.

12. The method of claim 11, wherein the overlaying the encoded first area image and the encoded second area image comprises:
extracting a predetermined-area image from the encoded first area image; and
overlaying the extracted predetermined-area image and the encoded second area image.

13. The method of claim 12, wherein the first area image includes a user image containing an appearance of the user, and the second area image includes a foreground image containing a foreground viewed by the user.

14. The method of claim 13, wherein, the encoding a first area image and a second area image that do not overlap with each other includes converting color formats of the user image and the foreground image.

15. The method of claim 13, wherein the extracting the predetermined-area image comprising:
extracting the predetermined-area image from the encoded user image to perform a sharpening operation with respect to the extracted predetermined-area image and
processing the foreground image to be smooth to remove a noise from the foreground image.

16. The method of claim 13, wherein, the overlaying the extracted predetermined-area image and the encoded second area image includes applying a transparency effect to at least one of the extracted predetermined-area image and the foreground image to overlay the extracted predetermined-area image and the user foreground image.

17. The method of claim 13, wherein, the overlaying the extracted predetermined-area image and the encoded second area image includes overlaying the extracted predetermined-area image and the user foreground image at every predetermined update cycle.

18. The method of claim 13, wherein, the overlaying the extracted predetermined-area image and the encoded second area image includes adjusting a size of the extracted predetermined-area image to overlay the size-adjusted predetermined-area image and the encoded second area image such that the size-adjusted pre-determined-area image is disposed at a predetermined position within the encoded second area image.

19. The method of claim 13, wherein, the overlaying the extracted predetermined-area image and the encoded second area image includes adjusting a position of the predetermined-area image in the encoded second area image to overlay the predetermined-area image and the encoded second area image so that the extracted predetermined-area image is disposed at a predetermined position within the encoded second area image.
